(19) United States
(12) Patent Application Publication
(10) Pub. No.: US 2002/0101413 A1
(43) Pub. Date: Aug. 1, 2002

(54) Light switching device

(76) Inventors: Mark Thomas Johnson, Eindhoven (NL); Iain Mcintosh Hunter, Brighton (GB); Paul Van Der Sluis, Eindhoven (NL); Anna-Maria Janner, Eindhoven (NL)

Correspondence Address: U.S. Philips Corporation, 580 White Plains Road, Tarrytown, NY, 10591, US

(21) Appl. No.: 10/042,449

(22) Filed: Jan. 8, 2002

(30) Foreign Application Priority Data
Jan. 12, 2001 (EP) 01200095.6

(51) Int. Cl. G09G 5/00

(52) U.S. Cl. 345/204

(57) ABSTRACT

In an active matrix display (20) comprising pixels based on switching mirror display elements (30) the driving circuit provides continous current in two directions (charge/discharge) and prevents device degradation

The invention relates to a light switching device that is reversibly switchable between at least a first state of reflecting light and a second state, the second state being either a state of absorbing light or a transmissive state, said device comprising a stack of layers including a switchable layer of an optically switchable material which brings about a switch from the first state to the second state of the device in particular a material in which switching is obtained by changing a concentration of hydrogen.

U.S. Pat. No. 5,905,590 describes a switching device comprising a switching film including hydrides of magnesium with other trivalent metals. By exchange of hydrogen, the switching film can be reversibly switched from a transparent state to a mirror-like (fully reflecting or scattering) state with zero transmission via an intermediate black absorbing state. The switching film is comprised in a stack of layers, which is deposited on a transparent substrate. By virtue of the optical effect the device can be used as an optical switching element, for example as a variable beam splitter, optical shutter, and for controlling the illuminance or the shape of light beams in luminaires. The switching device can also be used for data storage and in optical computing, and in applications such as architectural glass, vision control glass, sunroofs and rear-view mirrors. By making a pattern in the switching film and providing the patterned switching film with transparent electrodes a thin display can be manufactured.

It is a problem with this type of devices that since the speed of the switching effect is determined by the transport of hydrogen, the device is relatively slow.

It is an object of the invention to provide a switching device, which has an improved speed. To this end, the invention provides a display device in accordance with claim 1.

The invention is based on the insight that on the one hand the amount of charge required to address a pixel is so large that this cannot be loaded to a pixel during a number of subsequent addressing periods while on the other hand the pixel is comparable to a rechargeable battery. In the switching mirror device H-ions diffuse from one H-containing layer to the other whilst an electric current flows around the device. The optical properties depend on the state of charge of this hydrogen battery. By changing the polarity of the applied voltage the H-ions will flow back.

By introducing, according to the invention, for each pixel element a first series connection of two complementary switches between two voltage nodes, the common point of said series connection being connected to a first connection of the pixel element an intermediate voltage being provided to a second connection of the pixel element, the complementary switches being controlled by storage means, a large current can be introduced in both directions, allowing fast switching of the pixels.

In a first embodiment the display device comprises a second series connection of two complementary switches arranged in reverse sense with respect to the first series connection of two complementary switches between said two voltage nodes the second connection of the pixel element being connected to the common point of said second series connection and the second series of complementary switches being controlled by said storage means.

In a further embodiment the second connection of the pixel element is a fixed reference voltage. In this way the second series connection of two complementary switches can be dispensed with, which in the transmissive mode leads to a higher aperture.

Preferably the storage means comprise a capacitor element connected to the common point of said first series connection of complementary switches.

These and other aspects of the invention will now be described with reference to the drawings.

In the drawings,

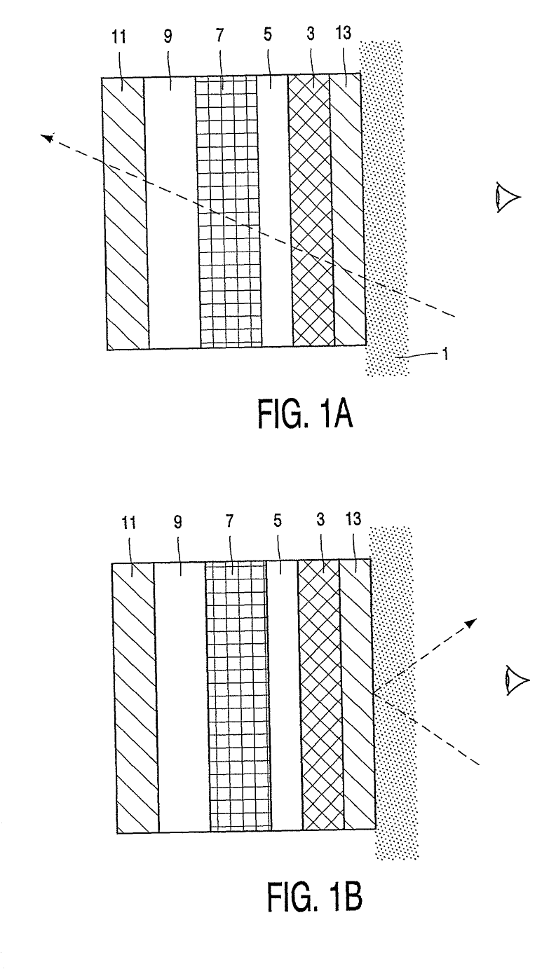

FIGS. 1A, 1B show a cross-section of a stack of layers of a switching mirror display according to the prior art;

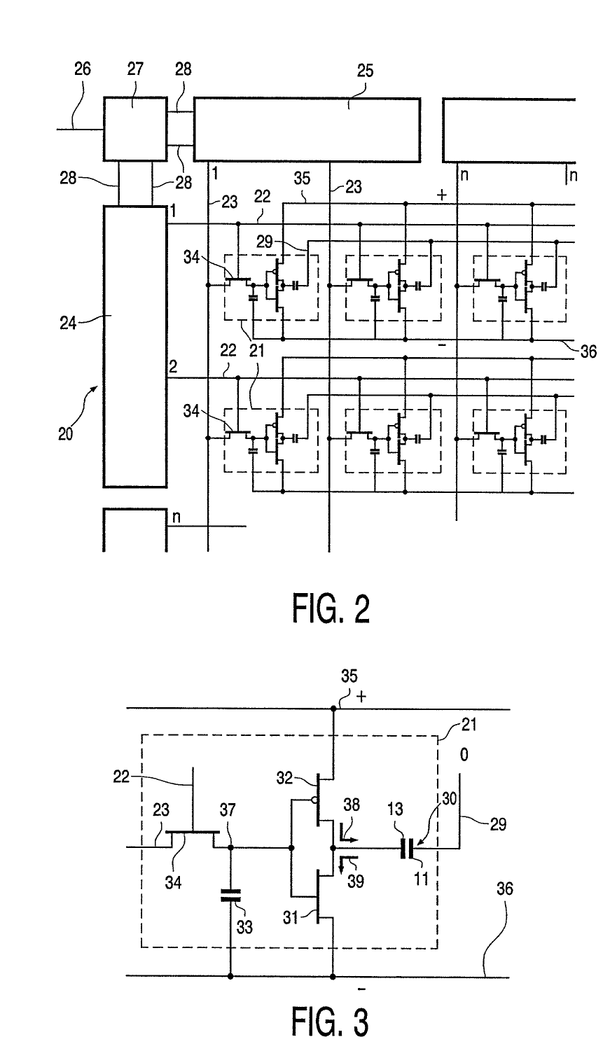

FIG. 2 shows part of a matrix of pixel elements of a switching mirror device according to the invention, while

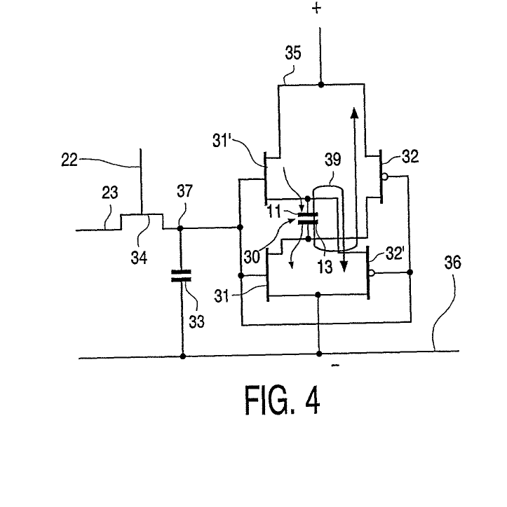

FIGS. 3 and 4 show schematically various embodiments of the device according to the invention.

The figures are schematically and not drawn to scale. In general like reference numerals identify like elements.

FIGS. 1A, 1B show a cross-section of a switching mirror device. The device comprises a transparent glass plate 1 on which a stack of layers is deposited by means of conventional methods, such as vacuum evaporation, sputtering, laser ablation, chemical vapor deposition or electroplating. The stack comprises a layer 3 of LMgHₓ (L being an element of the Lanthanide series of the Periodic System of Elements, Sc, Y or Ni) as a switching film with a thickness of about 200 nm, a palladium layer 5 with a thickness of about 5 nm, a layer 7 of an ion-conducting electrolyte with a thickness in the range of 0.1 to 10 μm and a hydrogen storage layer 9.

GdMgHₓ is a very suitable switching material, as far as optical properties and switching time is concerned, but other magnesium-lanthanide alloys might be employed as well. The switching film 3 may be reversibly switched between a low-hydrogen composition and a high-hydrogen composition. At intermediate H compositions the film is absorbing in various degrees. The various compositions have different optical properties. At a low-hydrogen content, the film has a metallic character, and is non-transparent. The film then reflects like a mirror. At a high hydrogen content, the film 3 is semiconductive and transparent, whereas at intermediate hydrogen concentration the switching film is absorbing.

The palladium layer 5 serves to increase the rate of hydriding or dehydriding, and thus the switching speed. Other electro-catalytic metals or alloys, such as platinum or nickel might also be used. In addition, this metal layer protects the underlying switching film 3 against corrosion by the electrolyte. The palladium layer 5 may have a thickness in the range between 2 and 100 nm. Thin layers of 2 to 10 nm are preferred, however, because the thickness of the film determines the maximum transmission of the switching device.

For a proper functioning also an H-storage layer 9 and an H-ion conducting electrolyte layer 7 are required. A good H-ion conducting electrolyte is ZrO₂₊ₓH_{y}. The electrolyte must be a good ion conductor, but it must be an isolator for electrons in order to prevent self-discharge of the device. Use is most preferably made of transparent solid-state electrolytes, because of the simplicity of the device; they prevent sealing problems, and the device is easier to handle.

If the transparent state of the switching mirror is required, then a good candidate for the storage layer is WO₃.

The stack is sandwiched between two transparent electroconductive electrode layers 11, 13 of, for example, indium-tin oxide (ITO). Electrode layers 11, 13 are connected to a(n) (external) current source (not shown). By applying a DC current, the low-hydrogen, mirror-like composition is converted to the high-hydrogen composition, which is transparent and neutral gray. The device now acts as a transparent window, as is shown in FIG. 1A by the dashed line. When reversing the current, the switching film 3 returns to the low-hydrogen state, which is mirror-like and non-transparent, as is shown in FIG. 1B. The switching time is comparable to that of conventional electrochromic devices. The device can operate at room temperature. Once the mirror has reached the desired optical state, virtually no current will flow through the device. This means that the display will hold information with a very low power. Moreover by using a current source, high voltages over the device are prevented which avoids degradation of the switching mirror device.

FIG. 2 shows a part of a display device 20 comprising a matrix of display circuit elements 21 at the areas of crossings of m row electrodes 22 (selection electrodes) and n column electrodes 23 (data electrodes). Row electrodes 22 are selected by means of a row driver 24, while column electrodes 23 are provided with data voltages via a column driver 25. Incoming data signals 26 are, if necessary, processed in a processor 27. Mutual synchronization occurs via control lines 28.

One embodiment of a display circuit elements 21 according to the invention will now be describe with reference to FIG. 3. It comprises a switching mirror device 30 as described with reference to FIGS. 1A, 1B, which for simplicity is represented by a capacitor. One transparent electroconductive electrode layer, 11 in this example, is connected to a fixed reference voltage (0V in this example) supplied by a voltage line 29. The other transparent electroconductive electrode layers 13, is connected to the common point of a series connection of complementary switches, in this example a n-type field effect transistor (TFT) 31 and a p-type field effect transistor (TFT) 32 between a positive voltage line 35 and a negative voltage line 36. Gate connections of n-type TFT 31 and p-type TFT 32 are interconnected and at the same time connected to one plate of a capacitor 33, which functions as a storage capacitor and is addressed by TFT 34 via m row electrodes 22 (selection electrodes) and n column electrodes 23 (data electrodes). The other plate is connected to negative voltage line 36.

During selection of a row via electrodes 22 the data voltage, as supplied by data electrode 23 is transferred to the gates of the n-type TFT 31 and p-type TFT 32 (node 37). Either one of the field effect transistors (dependent on the sign of the data voltage) starts conducting and acts as a current source and, dependent on the sign of the data voltage, starts charging (arrow 38) or discharging (arrow 39) the switching mirror element 30. During the hold time the remainder of rows in the display are selected. The storage capacitor 33 (which may be formed by the inherent gate-drain capacitance of TFT 31) ensures that, during this hold time, the current sources continue to deliver current needed for switching the switching mirror elements 30. This may be effected during one frame period (the time all lines are selected once), but may also last several frame times (depending on the size of the display, the dimensions of the mirrors and the TFTs). After completion of the charging (e.g. to be determined by means of a current detector) the current is switched off and the switching mirror element 30 will remain in the state it reached.

Apart from this the n-type and p-type transistor may be addressed by two separate select lines (while adding a further storage capacitor).

FIG. 4 shows an embodiment in which the voltage line 29 of FIG. 3 is dispensed with at the cost of an extra n-type field effect transistor (TFT) 31′ and an extra p-type field effect transistor (TFT) 32′. The second series connection of two complementary switches (TFTs 31′, 32′) is arranged in reverse sense with respect to the first series connection of two complementary switches (TFTs 31,32) between the two voltage lines 35,36. The transparent electroconductive electrode layer 11 is now connected to the common point of the series connection of TFTs 31′, 32′. Dependent on the data voltage transferred to node 37 either TFTs 31,31′ start conducting and charging (arrow 38) the switching mirror element 30 or TFTs 32, 32′ start conducting and discharging (arrow 39) the switching mirror element 30. The other reference numerals in FIG. 4 have the same meaning as those in FIG. 3.

The protective scope of the invention is not limited to the embodiments described. For example it may be applied to electrochromic devices in which the optically switching layer brings about a change in concentration of hydrogen, lithium or oxygen ions. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. Display device (20) being operable in a reflective mode (L) or in a transmissive mode (R) and having pixel elements for modulating light, each of said pixel elements comprising:
a stack of layers including a switchable layer (3) of an optically switchable material that switches the pixel elements from a first state to a second state, the second state being different from the first state, the first state and the second state being one of the following states: a reflective or scattering state, a transmissive state, or an absorbing state and means for modulating light in the reflective mode (L) by switching from a reflective state to a non-reflective state, and for modulating light in the transmissive (R) mode by switching from a transmissive state to a non-transmissive state, the non-reflective state being the transmissive state or the absorbing state and the non-transmissive state being the reflective or scattering state or the absorbing state,
the means for modulating light comprising for each pixel element a first series connection of two complementary switches (31,32) between two voltage connections (35,36), the common point of said series connection being connected to a first connection (13) of the pixel element an intermediate voltage being provided to a second connection (11) of the pixel element, the complementary switches being controlled by storage means (33), the display device comprising further means(22, 23, 34) for controlling the storage means.

2. Display device according to claim 1 in which the optically switchable layer brings about switching by changing a concentration of hydrogen.

3. Display device according to claim 1 in which the second connection of the pixel element is a fixed reference voltage (29).

4. Display device according to claim 1 comprising a second series connection of two complementary switches (31′,32′) arranged in reverse sense with respect to the first series connection of two complementary switches (31,32) between said two voltages the second connection of the pixel element (11) being connected to the common point of said second series connection and the second series of complementary switches being controlled by said storage means.

5. Display device according to claim 1 in which the storage means comprise a capacitor element connected to the common point of said first series connection of complementary switches.

6. Display device according to claim 4 in which the storage means comprise a capacitor element connected to the common points of said first and second series connections of complementary switches.

7. Display device according to claim 1 in which the pixel elements are provided in a matrix structure and the further means comprise select switches (34) controlled by select lines (22), to which data is presented via data lines (23).

8. Display device according to claims 4 and 7 in which the complementary transistors have separate select switches.

9. Display device according to claim 1 in which the switches comprise thin film transistors
